(19) United States
(12) Patent Application Publication
(10) Pub. No.: US 2021/0012438 A1
(43) Pub. Date: Jan. 14, 2021

(54) HOTEL EXPERIENCE SYSTEM AND METHOD

(71) Applicant: Octavia Ethridge, Bonsail, CA (US)

(72) Inventor: Octavia Ethridge, Bonsail, CA (US)

(21) Appl. No.: 16/838,983

(22) Filed: Apr. 2, 2020

Related U.S. Application Data
(60) Provisional application No. 62/871,222, filed on Jul. 8, 2019.

(51) Int. Cl. G06Q 50/14; G06Q 10/02; G06Q 50/12; G06K 7/14; G07C 9/00

(52) U.S. Cl. CPC G06Q 50/14; G06Q 10/02; G07C 9/00904; G06K 7/1413; G06Q 50/12

(57) ABSTRACT

A hotel experience system and method for providing a unique and entertaining experience for guests by simulating an adult immersive experience in a castle style hotel setting.

### BACKGROUND

### 1. Field of the Invention

The present invention relates generally to hotel and overnight accommodations, and more specifically to a hotel experience system and method that provides a guest with an adult immersive experience in a castle style hotel setting, thereby providing the guest with a unique and entertaining experience.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a flowchart of a method associated with the present invention; and

FIG. 2 is a schematic of possible remotes associated with the various packages of the present invention.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

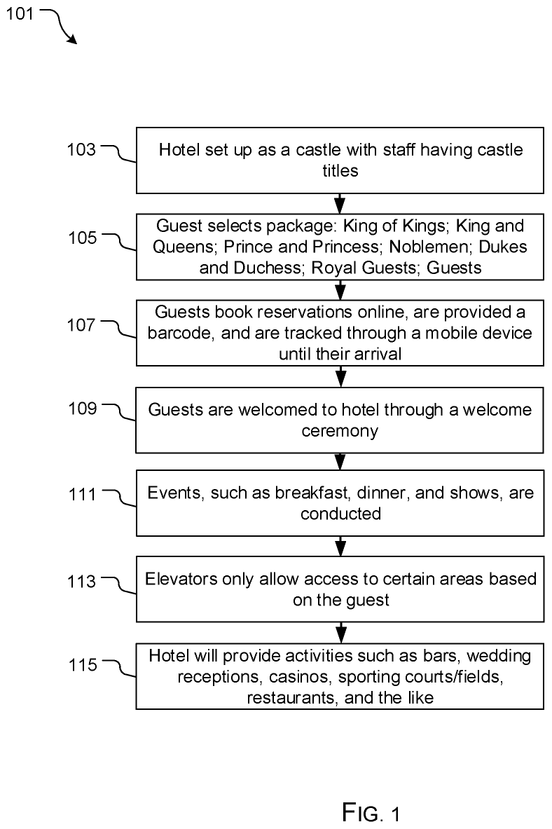

Referring now to the drawings wherein like reference characters identify corresponding or similar elements throughout the several views, FIG. 1 depicts a flowchart of a method in accordance with a preferred embodiment of the present application.

The system and method of the present invention is for guest to engage in a castle/royalty experience through a hotel stay.

As shown in flowchart 101, a hotel will first be established with a plurality of amenities and rooms, wherein the theme of the hotel will be focused on royalty and the staff of the hotel will have castle style titles, as shown with box 103. Some of the titles include: (1) Butler—works for Kings and Queens only and care for the cellar and in charge of wine and beer; (2) Cook—works for Kings and Queens only as personal chef; (3) Knights—provides security; (4) Watchmen—acts as head of security; (5) Flower Girls—Kings and Queens personal; (6) Peasants—gardeners and janitors; (7) Dancers—Dance at royal feasts for cultured king or queen.

During the booking process, a guest will select their desired package, as shown with box 105. The packages will include: (1) King of Kings; (2) King & Queen; (3) Prince and Princess; (4) Nobleman; (5) Dukes and Duchess; (6) Royal Guests; (7) Guests. It should be appreciated and understood that the features provided to the guest will depend on their selected package.

After a guest books a reservation online, they will be provided with a barcode, wherein a mobile device with the barcode is used to check in and provide tracking to the hotel, thereby allowing for the hotel to determine when the guests will arrive, as shown with box 107. This feature allows for the hotel to be prepared for the arrival of the guests, thereby ensuring that the guest feels like a royal.

Depending on the package selected, a guest may be welcomed with a ceremony as shown with box 109. Such a ceremony could include a trumpet sounded to alert everyone that a royal is approaching the castle, thereby alerting other guests and staff accordingly. Further, in some embodiments, a royal guest could elect to be carried to the front steps.

One or more events can be conducted at the castle, the events can include shows, dinners, breakfasts, and the like, as shown with box 111. It is contemplated that one particular event is to occur at sunrise, wherein a trumpet will be sounded, and breakfast will be served to the royal guests at appointed times.

During a guest stay, they will only have access to particular locations based on their package, as shown with box 113. The guests will have to scan a key or ID in order to receive access, thereby providing security for the guests.

The hotel/castle will include a plurality of amenities for the guests, including bars, casinos, sporting fields/courts, restaurants and the like, as shown with box 115.

It should be appreciated that one of the unique features believed characteristic of the present application is the immersive experience provided to guests that allow for a guest to be treated like a royal for a period of time. This feature is accomplished through the providing of the features discussed above to guests. It should be appreciated that the system and method can be applied to multiple venues, such as a cruise, an airline, an apartment complex, and the like. The features can vary for each venue, but the overall idea is the same.

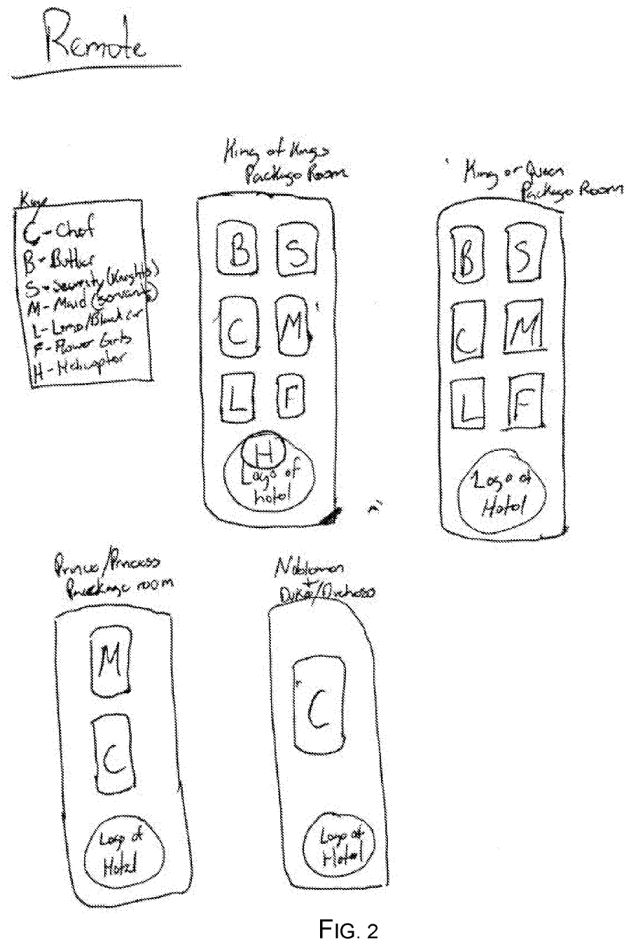

In FIG. 2, examples of remotes associated with each package are shown, wherein the guests can utilize the remotes to call for various services.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. An immersive experience system, comprising:
a plurality of venues hosts the immersive experience; and
a plurality of mediums that allows a plurality of guests to make reservations;
wherein the plurality of guests selects their desired immersive package which includes a plurality of titles;
wherein the plurality of venues serves the plurality of guests according to the title selected from the desired immersive package; and
wherein the plurality of venues offers a plurality of events, activities, amenities, and accommodations for the plurality of guests.

2. A method of providing an immersive experience, the method comprising:
providing the system of claim 1;
allowing a plurality of guests to select a desired stay package through a plurality of means;
having a welcome ceremony for the plurality of guests; and
offering a plurality of events and activities for the plurality of guests.
